(19) United States
(12) Patent Application Publication
(10) Pub. No.: US 2013/0159178 A1
(43) Pub. Date: Jun. 20, 2013

(54) System and Method For Loading A Virtual Token Managed By A Mobile Wallet System

(71) Applicants: Christopher Q. Colon, Atlanta, GA (US); Scott P. Monahan, Atlanta, GA (US); Robert L. Dessert, Atlanta, GA (US)

(72) Inventors: Christopher Q. Colon, Atlanta, GA (US); Scott P. Monahan, Atlanta, GA (US); Robert L. Dessert, Atlanta, GA (US)

(73) Assignee: FIRETHORN MOBILE, INC., Atlanta, GA (US)

(21) Appl. No.: 13/348,763

(22) Filed: Jan. 12, 2012

Related U.S. Application Data
(60) Provisional application No. 61/570,370, filed on Dec. 14, 2011.

(51) Int. Cl. G06Q 20/36

(52) U.S. Cl. 705/41

(57) ABSTRACT

A method and system include receiving a payment account number from a token, such as a traditional credit card. Either the payment account number or a token is communicated over a communications network to a mobile wallet system and/or a vault. A first authorization code may be generated in response to receiving the payment account number or token. Next, the first authorization code is then transmitted over the communications network for relaying the first authorization code to a portable computing device, such as a mobile phone. The portable computing device receives the authorization code and re-transmits the code (as a second authorization code) over the communications network. Subsequently, the first and second code from the portable computing device are compared to determine if a match exists. If a match exists, then the payment account number is loaded into the mobile wallet system for use as a virtual token.

### PRIORITY AND RELATED APPLICATIONS STATEMENT

This patent application claims priority under 35 U.S.C. §119(e) to U.S. provisional application Ser. No. 61/570,370, entitled, “SYSTEM AND METHOD FOR LOADING A VIRTUAL TOKEN MANAGED BY A MOBILE WALLET SYSTEM,” filed on Dec. 14, 2011. The entire contents of which is hereby incorporated by reference.

### DESCRIPTION OF THE RELATED ART

Portable computing devices (PCDs) are becoming personal necessities for people on personal and professional levels. These devices may include cellular telephones, portable digital assistants (PDAs), portable game consoles, palmtop computers, and other portable electronic devices.

PCDs are very helpful in situations like consumer transactions in which a PCD may be used to facilitate payment for a consumer transaction. In order for a PCD to be used to facilitate payment in a consumer transaction, account information from one or more payment accounts must be associated with the PCD. Currently, a consumer who desires to use a PCD as payment tool must use a computer to enter payment account information in a database which will associate the PCD with the payment account information. This process of keying-in payment account information using a computer may be very time consuming and prone to typographical errors. This challenge of entering payment account information into a database may prevent some users from ever contemplating using their PCD as form of payment for a consumer transaction.

Accordingly, what is needed in the art is an easier method and system for entering data from payment accounts into a database which is not prone to human error.

### SUMMARY OF THE DISCLOSURE

A method and system for loading a virtual card of a mobile wallet system are disclosed. The method includes receiving a payment account number from a token, such as magnetic stripe card or integrated circuit (“IC”) card. Next, either the payment account number or a token is communicated over a communications network to a mobile wallet system and/or a vault. A first authorization code may then be generated in response to receiving the payment account number or token.

Next, the first authorization code is then transmitted over the communications network for relaying the first authorization code to a portable computing device, such as a mobile phone. The portable computing device receives the authorization code and re-transmits the code over the communications network. Next, the original authorization code and re-transmitted code from the portable computing device are compared to determine if a match exists. If the codes match, then the payment account number taken from the token is loaded into the mobile wallet system for use as a virtual token.

The machine for reading the physical token may comprise at least one of a magnetic stripe reader, a barcode reader, a near field communications (“NFC”) reader, a reader that uses radio-frequency communications, and a portable computing device coupled to the Internet.

The physical token may comprise at least one of a card with a magnetic stripe, a card with a smart chip or integrated-circuit (“IC”), a card that uses near-field-communications (“NFC”), a card with a barcode, a mobile device with a system that uses NFC, and a mobile device bearing a bar code.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all Figures.

FIG. 1 is a front plan view of a first aspect of a portable computing device (PCD) in a closed position;

FIG. 2 is a front plan view of the first aspect of a PCD in an open position;

FIG. 3 is a block diagram of a second aspect of a PCD;

FIG. 4 is a diagram of exemplary computer architecture for a mobile wallet system;

FIG. 5A is a diagram of a screen listing options for managing an account having a virtual token;

FIG. 5B is a diagram of a first detailed purchase/redemption presentation screen for an account transaction that has a virtual token;

FIG. 5C is a diagram of a second detailed purchase/redemption presentation screen for an account transaction that has a virtual token;

FIG. 5D is a diagram of a third detailed purchase/redemption presentation screen for an account transaction that has a virtual token;

FIG. 6 is a diagram of a system for loading a virtual token managed by a mobile wallet system;

FIG. 7A is a flowchart illustrating a method for loading a virtual token of a mobile wallet system;

FIG. 7B is a continuation flowchart of FIG. 7A illustrating a method for loading a virtual token of the mobile wallet system;

FIG. 7C is a continuation flowchart of FIG. 7B illustrating a method for loading a virtual token of the mobile wallet system.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) wireless technology and fourth generation (“4G”) wireless technology, greater bandwidth availability has enabled more portable computing devices with a greater variety of wireless capabilities. Therefore, a portable computing device may be a cellular telephone, a pager, a PDA, a smartphone, a navigation device, or a hand-held computer with a wireless connection or link.

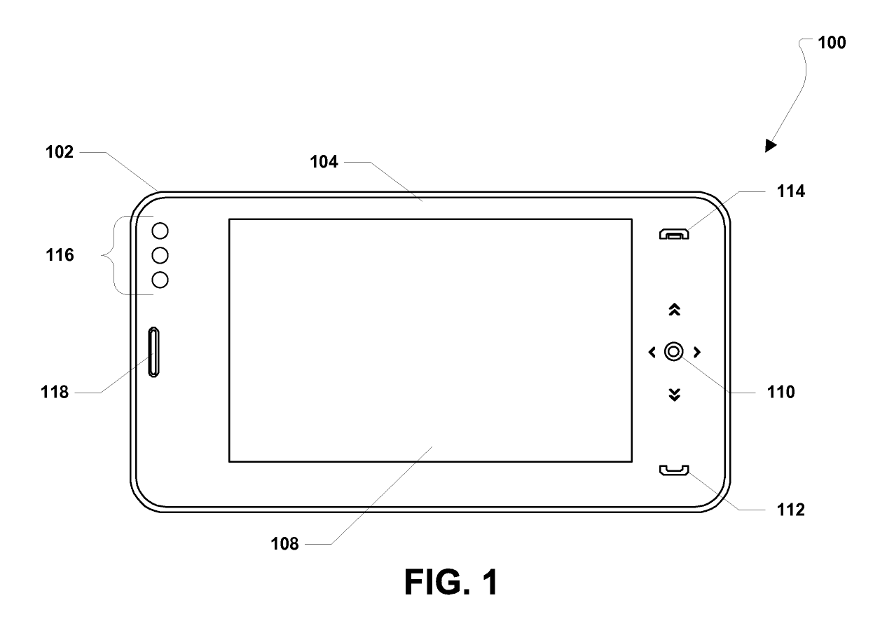

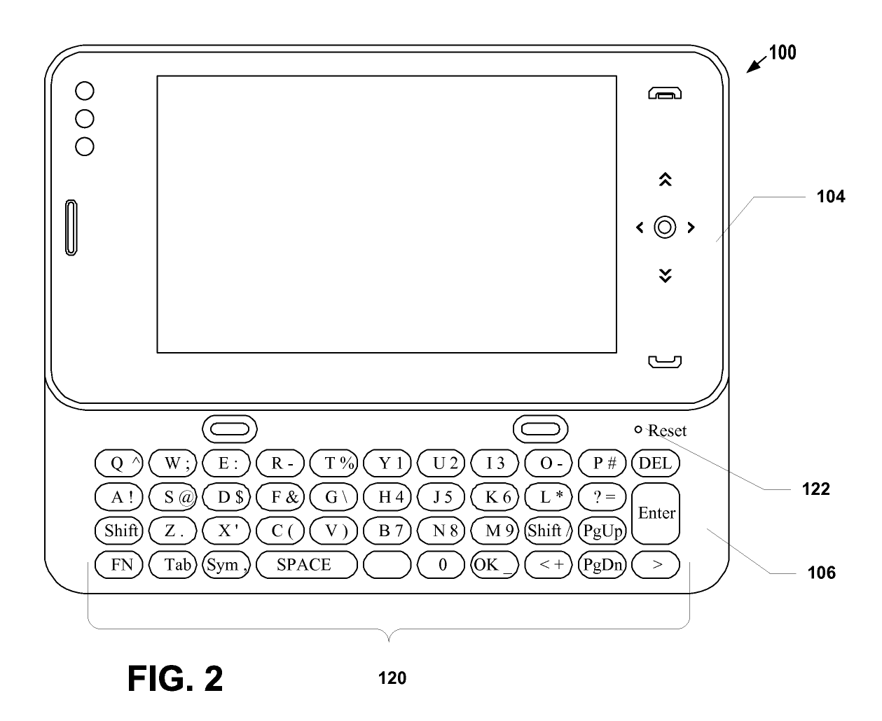

Referring initially to FIG. 1 and FIG. 2, an exemplary portable computing device (PCD) is shown and is generally designated 100. As shown, the PCD 100 may include a housing 102. The housing 102 may include an upper housing portion 104 and a lower housing portion 106 (FIG. 2). FIG. 1 shows that the upper housing portion 104 may include a display 108. In a particular aspect, the display 108 may be a touch screen display. The upper housing portion 104 may also include a trackball input device 110. Further, as shown in FIG. 1, the upper housing portion 104 may include a power on button 112 and a power off button 114. As shown in FIG. 1, the upper housing portion 104 of the PCD 100 may include a plurality of indicator lights 116 and a speaker 118. Each indicator light 116 may be a light emitting diode (LED).

In a particular aspect, as depicted in FIG. 2, the upper housing portion 104 is movable relative to the lower housing portion 106. Specifically, the upper housing portion 104 may be slidable relative to the lower housing portion 106. As shown in FIG. 2, the lower housing portion 106 may include a multi-button keyboard 120. In a particular aspect, the multi-button keyboard 120 may be a standard QWERTY keyboard. The multi-button keyboard 120 may be revealed when the upper housing portion 104 is moved relative to the lower housing portion 106. FIG. 2 further illustrates that the PCD 100 may include a reset button 122 on the lower housing portion 106.

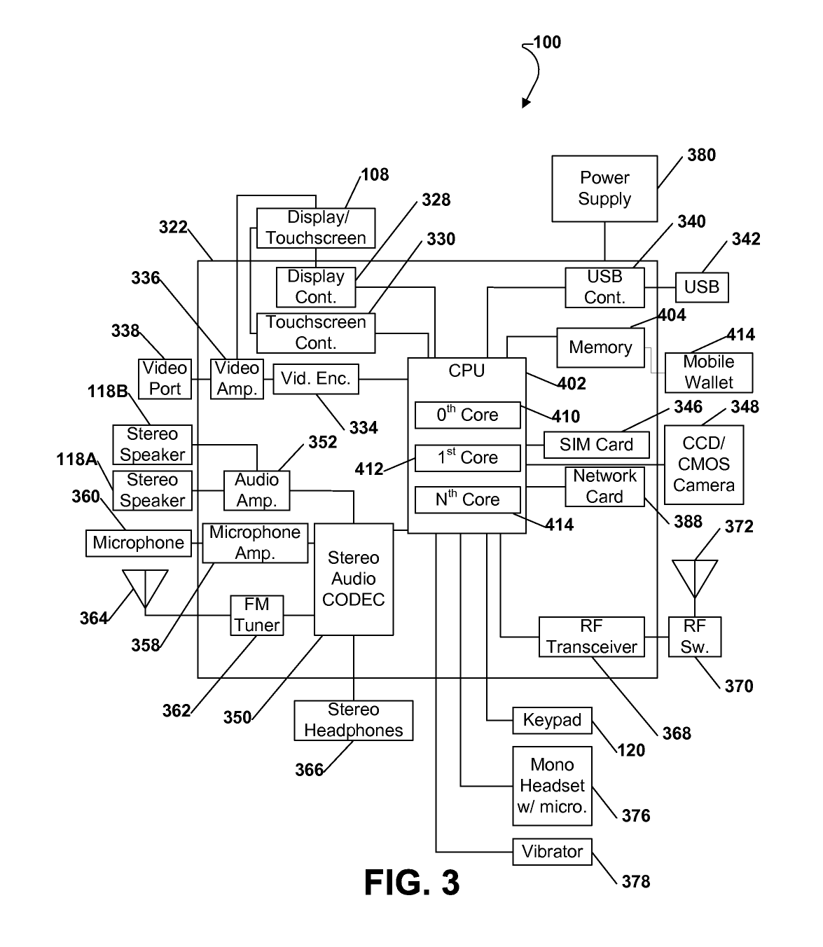

Referring to FIG. 3, an exemplary, non-limiting aspect of a portable computing device (PCD) is shown and is generally designated 100. As shown, the PCD 100 includes an on-chip system 322 that includes a multicore CPU 402. The multicore CPU 402 may include a zeroth core 410, a first core 412, and an Nth core 414.

As illustrated in FIG. 3, a display controller 328 and a touch screen controller 330 are coupled to the multicore CPU 402. In turn, a touch screen display 108 external to the on-chip system 322 is coupled to the display controller 328 and the touch screen controller 330.

FIG. 3 further illustrates a video encoder 334, e.g., a phase alternating line (PAL) encoder, a sequential color a memoire (SECAM) encoder, or a national television system(s) committee (NTSC) encoder, are coupled to the multicore CPU 402. Further, a video amplifier 336 is coupled to the video encoder 334 and the touch screen display 108. Also, a video port 338 is coupled to the video amplifier 336. As depicted in FIG. 3, a universal serial bus (USB) controller 340 is coupled to the multicore CPU 402. Also, a USB port 342 is coupled to the USB controller 340. A memory 404 and a subscriber identity module (SIM) card 346 may also be coupled to the multicore CPU 402. Further, as shown in FIG. 3, a digital camera 348 may be coupled to the multicore CPU 402. In an exemplary aspect, the digital camera 348 is a charge-coupled device (CCD) camera or a complementary metal-oxide semiconductor (CMOS) camera.

As further illustrated in FIG. 3, a stereo audio CODEC 350 may be coupled to the multicore CPU 402. Moreover, an audio amplifier 352 may coupled to the stereo audio CODEC 350. In an exemplary aspect, a first stereo speaker 118A and a second stereo speaker 118B are coupled to the audio amplifier 352. FIG. 3 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 3 further indicates that a radio frequency (RF) transceiver 368 may be coupled to the multicore CPU 402. An RF switch 370 may be coupled to the RF transceiver 368 and an RF antenna 372. As shown in FIG. 3, the keypad 120 may be coupled to the multicore CPU 402. Also, a mono headset with a microphone 376 may be coupled to the multicore CPU 402. Further, a vibrator device 378 may be coupled to the multicore CPU 402. FIG. 3 also shows that a power supply 380 may be coupled to the on-chip system 322. In a particular aspect, the power supply 380 is a direct current (DC) power supply that provides power to the various components of the PCD 100 that require power. Further, in a particular aspect, the power supply is a rechargeable DC battery or a DC power supply that is derived from an alternating current (AC) to DC transformer that is connected to an AC power source.

FIG. 3 further illustrates that the PCD 100 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, or any other network card well known in the art. Further, the network card 388 may be incorporated into a chip, i.e., the network card 388 may be a full solution in a chip, and may not be a separate network card 388.

As depicted in FIG. 3, the touch screen display 108, the video port 338, the USB port 342, the camera 348, the first stereo speaker 118A, the second stereo speaker 118B, the microphone 360, the FM antenna 364, the stereo headphones 366, the RF switch 370, the RF antenna 372, the keypad 374, the mono headset 376, the vibrator 378, and the power supply 380 are external to the on-chip system 322.

In a particular aspect, one or more of the method steps described herein may be stored in the memory 404 as computer program instructions. These computer program instructions may take the form of a mobile wallet application 414. These instructions via mobile wallet application 414 may be executed by the multicore CPU 402 in order to perform the methods described herein. Further, the multicore CPU 402, the memory 404, mobile wallet application 414, or a combination thereof may serve as a means for executing one or more of the method steps described herein in order to load data to a virtual token of a mobile wallet system 101.

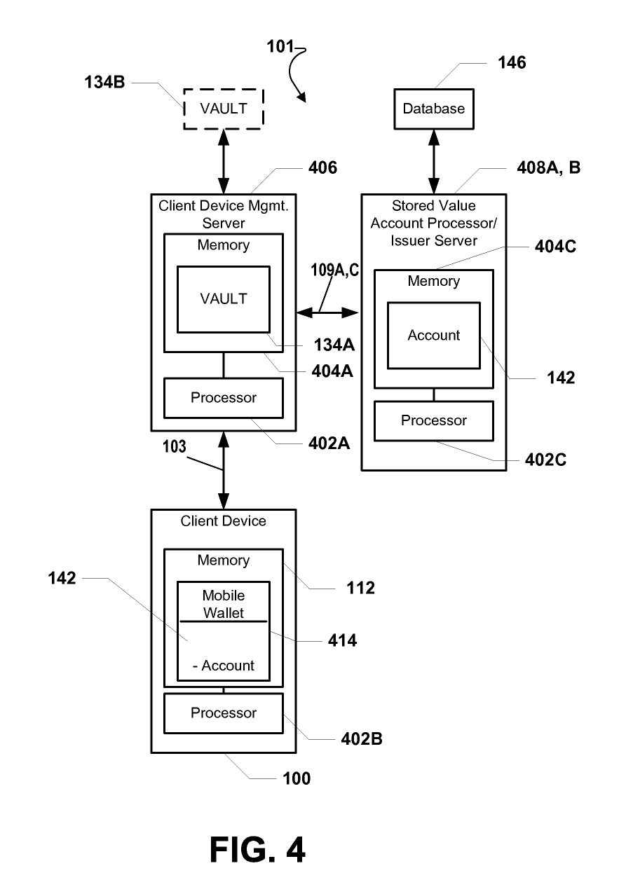

FIG. 4 is a diagram of exemplary computer architecture for a mobile wallet system 101. The exemplary architecture 101 may include a client device or PCD 100. A client device server 406 may be connected to the mobile client device 100. The client device management server 406 may be connected to the mobile device 100 via a wired or wireless communications link 103, such as a mobile telephone network. Further, the client device management server 406 may be connected to an account processor/issuer server 408A,B via a direct communications link 109A,C, such as by a WAN. The account processor server 408A and the account issuer server 408B may be two physically separate devices or software (not illustrated), or alternatively, the functions of these two elements 408A, B may be performed by a single device or software module as illustrated in FIG. 4. One of ordinary skill in the art will appreciate that either option may be selected depending upon computer architecture design constraints and without departing from the scope of this disclosure.

As illustrated in FIG. 4, the client device 100 may include a processor 402A and a memory 404A coupled to the processor 402A. The memory 112 may include instructions for executing one or more of the method steps described herein. Further, the processor 402A and the memory 404A may serve as a means for executing one or more of the method steps described herein. As indicated, the memory 404A may also include vault/mobile wallet 134. The vault/mobile wallet 134 may be accessible by the mobile device 100 by the client device management server 406.

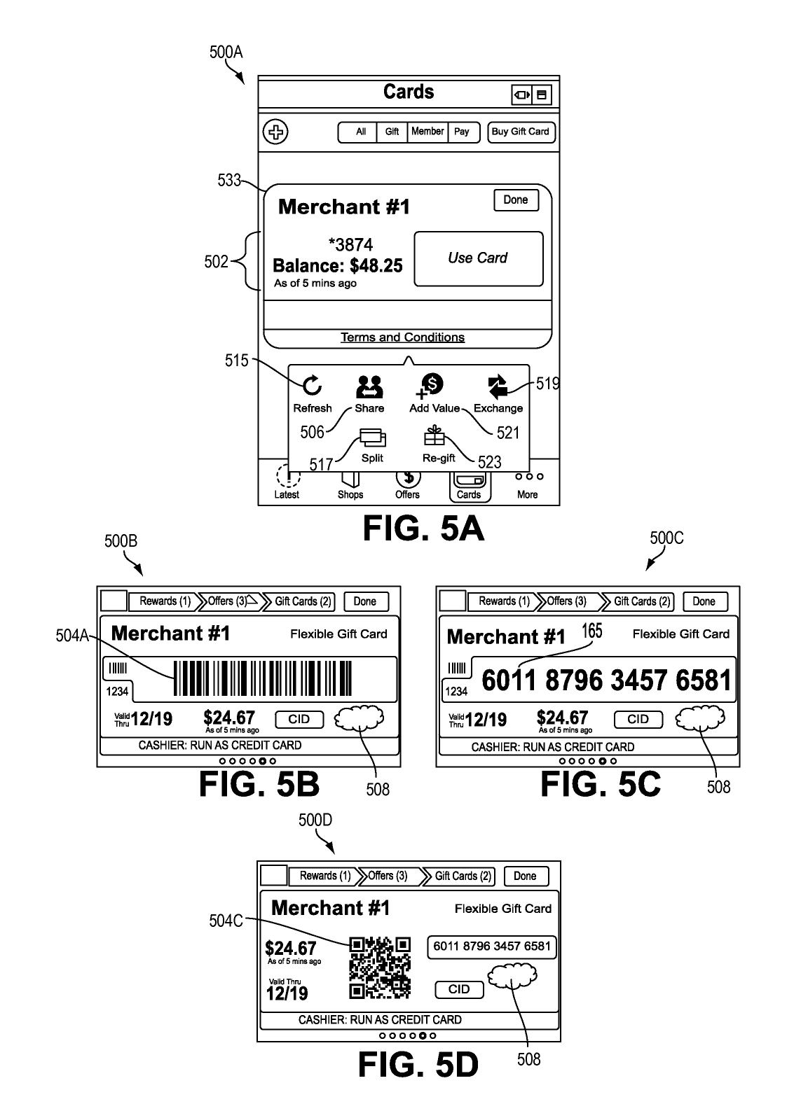

The vault/mobile wallet 414 of the PCD 100 may provide functions similar to a traditional wallet in that it may contain information on accounts 142 and provide virtual tokens 544 (See FIG. 5) that allow a user to access money or credit from the client device management server 406, and which allows a user to carry such information in his or her pocket within the PCD 100. While depicted as a single unitary structure in FIG. 4, the mobile wallet/vault 134A of the client device management server 106 may comprise two physically separate entities or systems such as the second vault 134B illustrated with dashed lines between the client device management server 406 and account processor/issuer server 408A,B.

FIG. 4 shows that the client device management server 406 may include a processor 402A and a memory 404A coupled to the processor 402A. The memory 402A may include instructions for executing one or more of the method steps described herein. Further, the processor 402A and the memory 404A may serve as a means for executing one or more of the method steps described herein. As illustrated, the memory 404A may include a mobile wallet system/vault 134 that provides information for one or more accounts 142 as well as other types of accounts, such as, but not limited to, credit card accounts and bank accounts that reside with the account processor/issuer server 408A, B.

The mobile wallet system/vault 134 within the client device management server 406 may be similar to the mobile wallet 414 stored within the PCD 100. Further, the mobile wallet system/vault 134 within the client device server 406 may include substantially the same information as the mobile wallet 414 stored within the mobile client device 100.

As depicted in FIG. 4, the account processor/issuer server 408A, B may include a processor 402C and a memory 404C coupled to the processor 402C. The memory 404C may include instructions for one or more of the method steps described herein. Further, the processor 402C and the memory 404C may serve as a means for executing one or more of the method steps described herein. As illustrated, the memory 404C may include an account 142 associated with a user of the mobile device 100. A database 146B may also be connected to the account processor server/issuer server 408A,B. The database 146 may include account information associated with the account 142 and account information associated with other user accounts 142 associated with other mobile devices 100.

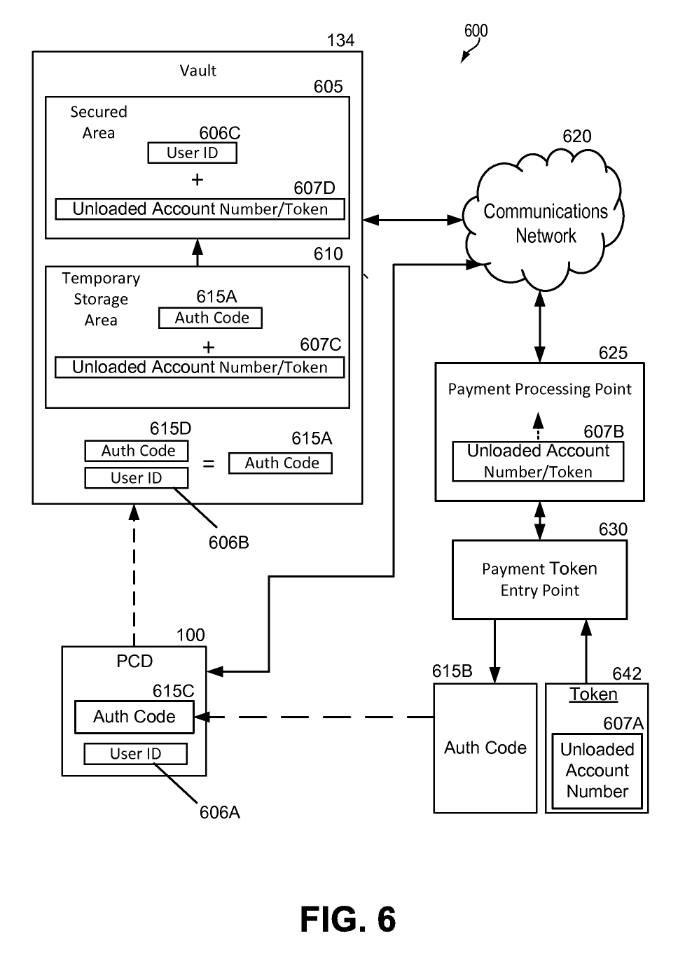

Referring to FIG. 5A, this is a diagram of a screen 500A that lists options for managing an account 142 in which account data has already been loaded into the system 101 of FIG. 4. That is, FIGS. 5A-5D represent at least one objective of the system 600 illustrated in FIG. 6 described below: to provide loading of a virtual token 533 managed by mobile wallet system/vault 134 of FIG. 4 based on accounts 142 generally associated with physical tokens, such as stored value cards (i.e. gift cards and rewards cards), credit cards, debit cards, bank cards, library cards, etc.

Once an account 142 is loaded into the system 101 of FIG. 4, an operator of a PCD 100 may be presented with a variety of options to manage his or her account with the PCD 100. For example, the options screen 500A of FIG. 5A may comprise virtual token 533 having a listing of account information 502 associated with an account 142 (See FIG. 4) such as the name of the merchant “Merchant #1”, the last four digits of the multi-digit digit PAN, a current value, and a graphical representation of a magnetic stripe so that the user of the client device 100 recognizes that possible use of the virtual token 533.

The options screen 500A may further comprise icons that are associated with different options for managing the account 142. Such icons may be illustrated with symbols to suggest their intended functions. In the exemplary embodiment illustrated in FIGS. 5A-5B, the account 142 comprises a stored value account associated with the virtual token 533. One of ordinary skill in the art recognizes that other accounts are included within the scope of this disclosure, and may include, but are not limited to, gift cards, credit card accounts, debit card accounts, any form of banking accounts, etc.

In the exemplary stored value account embodiment illustrated in FIG. 5, the icons may be associated with, but are not limited to, the following stored value type functions/operations: refresh 515, a share function 506, a split function 517, an add value operation 521, an exchange operation 519, and a re-gift operation 523.

If the share card icon 506 is selected by a user, then the user of the recipient client device 502B may send a portion or all of the value associated with the stored value account 142 to another recipient client device 100. Activating this icon or button 506 may initiate another user interface that instructs the user how the value associated with the stored value account 142 may be shared with another recipient client device 100. The recipient of a shared stored value account 142 may have reduced functionality for shared stored value accounts 142. The shared stored value account recipient may be restricted to the following actions: viewing the current available balance of the shared stored value account 142; and presenting the shared stored value account 142 at a merchant point-of-sale (“POS”) device.

If the refresh icon 515 is selected by a user, then the activation of this icon may allow the screen 500A to refresh itself so that a current balance of the virtual token 702 is displayed in the account information 502. As noted previously, if the stored value account 142 associated with the virtual token 533 is being shared, then other users may be making purchases or withdrawals relative to the stored value account 142. In such circumstances of simultaneous use of the same stored value account 142, the current account balance becomes very relevant to a user who is about to purchase a good or service using the virtual token 533 and corresponding stored value account 142.

The split icon 517 when selected may activate an operation that allows the user of the recipient client device to split the funds associated with a sixteen digit, single personal account number (“PAN”) 165 so that two sets of the total value of the funds are now associated with two PANs 165. In essence, this split function allows the user of the recipient client device 100 to create two virtual tokens 533 having two values based on single virtual token 533 that had an original value.

The exchange icon 519 allows a user of the client device 100 to exchange value associated with one merchant for value with another merchant. The re-gift icon 523 allows a user of a client device 502 to send a stored value account to another recipient client device 100. Other options for managing a stored value account 142 (and other types of accounts 142) though not specifically illustrated, are within the scope of this disclosure as understood by one of ordinary skill in the art.

FIG. 5B is a diagram of a first detailed purchase/redemption presentation screen 500B for a stored value transaction exemplary embodiment. This screen 500B may be generated in response to a user of the client device 100 selecting the “use card” button listed on the virtual token 533 of FIG. 5A. A merchant may use a scanner to enter a one-dimensional barcode 504A. Exemplary one-dimensional bar codes may include, but are not limited to, U.P.C., Codabar, Code 25—Non-interleaved 2 of 5, Code 25—Interleaved 2 of 5, Code 39, Code 93, Code 128, Code 128A, Code 128B, Code 128C, Code 11, CPC Binary, DUN 14, EAN 2, EAN 5, EAN 8, EAN 13, Facing Identification Mark, GS1-128 (formerly known as UCC/EAN-128), GS1 DataBar formerly Reduced Space Symbology (“RSS”), HIBC (HIBCC Bar Code Standard), ITF-14, Latent image bar code, Pharmacode, Plessey, PLANET, POSTNET, Intelligent Mail Bar code, MSI, PostBar, RM4SCC/KIX, JAN, and Telepen.

The current value of the stored value account 142 may be retrieved by the client device 100 immediately prior to the display of the account information and the barcode 504A to insure it is accurate as possible at the time of sale. The amount of time for the client device 100 to retrieve the current value of the stored value account 142 may be approximately under five seconds, depending on network availability and other factors. If a delay is experienced, such as on the order of greater than ten seconds, then the last cached balance along with an “as of” date stamp may be displayed by the client device 100.

Screen 500B may be displayed when a user of the recipient client device 100 desires to redeem a stored value account 142 for purchasing goods or services at a point of sale (“POS”) terminal in a store or if the user wishes to purchase goods and/or services over a telephone network. Screen 500B may also comprise a “watermarked” background 508 that is displayed behind or adjacent the one-dimensional barcode 504A. This “watermarked” background 508 may contain an image that has a pattern which may be difficult to reproduce and may be human-readable, such as by a cashier who may check the detailed purchase screen 500 for authenticity. Screen 500B may include the ability to present multiple virtual tokens 533 associated with the same merchant. These virtual tokens 533 may be associated with other accounts 142, external account information, including loyalty, membership or reward accounts, merchant stored value accounts, or product discount certificates. Each of these virtual tokens 533 may be displayed separately upon selection by a user.

Information on the detailed purchase screen 500B is usually presented in a clear, high-contrast manner so that it is easily readable by a cashier at a standard distance, such as a distance of approximately thirty-six inches, preferably in a manner consistent with how a traditional physical token, like a credit card number, is typically displayed to a cashier.

FIG. 5C is a second diagram of a detailed purchase/redemption presentation screen 500C for a stored value transaction. This detailed purchase screen 500B is generally a human-readable display of stored value account information that may be used by a cashier to manually enter into a point-of-sale terminal to submit for authorization or for a user to enter into a website for an on-line purchase over the Internet. A merchant may key-in the account information, such as a PAN 165.

FIG. 5D is a third diagram of a detailed purchase/redemption presentation screen 500D for a stored value transaction. This diagram is similar to FIG. 5B, however, instead of a one-dimensional bar code being displayed, a two-dimensional barcode 504B is displayed for a POS terminal that may scan such a barcodes 504B. The 2-D bar code may include, but is not limited to, the following symbologies: Aztec Code, 3-DI, ArrayTag, Small Aztec Code, Chromatic Alphabet, Chromocode, Codablock, Code 1, Code 16K, Code 49, ColorCode, Compact Matrix Code, CP Code, CyberCode, d-touch, DataGlyphs, Datamatrix, Datastrip Code, Dot Code A, EZcode, Grid Matrix Code, High Capacity Color Bar code, HueCode, INTACTA.CODE, InterCode, MaxiCode, mCode, MiniCode, Micro PDF417, MMCC, Nintendo e-Reader#Dot code, Optar, PaperDisk, PDF417, PDMark, QR Code, QuickMark Code, Semacode, SmartCode, Snowflake Code, ShotCode, SuperCode, Trillcode, UltraCode, UnisCode, VeriCode, VSCode, WaterCode, for example.

FIG. 6 is a diagram of a system 600 for loading a virtual token managed by a mobile wallet system 101, such as illustrated in FIG. 4. The system 600 includes the mobile wallet/system vault 134 of FIG. 4 as well as a communications network 620, a payment processing point 625, and a payment token entry point 630. The communications network 620 may comprise a wide area network (“WAN”), a local area network (“LAN”), the Internet, a Public Switched Telephony Network (“PSTN”), a paging network, or a combination thereof. The communications network 620 may be established by broadcast RF transceiver towers (not illustrated). However, one of ordinary skill in the art recognizes that other types of communication devices besides broadcast RF transceiver towers are included within the scope of this disclosure for establishing the communications network 620.

The mobile wallet system/vault 134 as described above in connection with FIG. 4 is coupled to a payment processing point 625 via the communications network 620. The payment processing point 625 may comprise an electronic cash register (“ECR”), a store controller, a credit switch, a merchant acquirer, or any combination thereof as understood by one of ordinary skill in the art. The payment processing point 625 is coupled to a payment token entry point 630.

The payment token entry point 630 may comprise any type of point-of-sale (“POS”) device, such as, but not limited to, a terminal, a kiosk, and other similar devices which may also include a magnetic stripe reader, a barcode reader, a near field communications (“NFC”) reader, a reader that uses Bluetooth, a reader with Internet linking capability, and any combination thereof. The payment token entry point 630 may read traditional physical tokens 642 that are associated with an unloaded account number 607A in which the operator of the PCD 100 desires to be managed by the mobile wallet system/vault 134. Once the unloaded account number 607A becomes “loaded” in the system 101, the account number takes on reference character 142 referenced in earlier figures, such as FIG. 4.

Traditional physical tokens 642 may include, but are not limited to, cards with magnetic stripes, cards with smart chips or integrated-circuit (“IC”) cards, NFC cards, cards with barcodes, etc. Usually, traditional physical token 642 are designed such that they can be read by a machine that typically embodies the payment token entry point 630. While the payment token entry point 630 and the payment processing point 625 have been illustrated as two separate physical units or devices, one of ordinary skill the art recognizes that these two devices may function and be designed as a single unitary device in alternate embodiments (not illustrated). The function of the payment token entry point 630 and the payment processing point 625 is to upload an unloaded account number 607B that is associated with the physical token 642 to the mobile wallet system/vault 134.

The mobile wallet system/vault 134 may comprise a secured area 605 and a temporary storage area 610. The mobile wallet system/vault 134 may generate an authorization code 615A upon receiving an unloaded account number or token 607C from the payment processing point 625 which transmitted the data across the communications network 620. Prior to this transmission from the payment processing point 625, the payment token entry point 630 retrieves the unloaded account number 607A from the physical token 642. In some exemplary embodiments, the payment token entry point 630 may provide a data token instead of the actual unloaded account number 607B for security purposes as understood by one of ordinary skill the art. Therefore, the payment token entry point 630 may pass either the actual unloaded account number 607B or a tokenized version of this account number to the payment processing point 625. This unloaded account number or tokenized version of the account number 607B is transmitted by the payment processing point 625 over the communications network 620 to the mobile wallet system/vault 134.

As noted previously, upon receipt of the unloaded account number or token 607C from the payment processing point 625, the mobile wallet system/vault 134 may generate an authorization code 615A that is transmitted over the communications network 622 the payment processing point 625. The payment processing point 625, in turn, passes this authorization code 615B to the payment token entry point 630 which generates the version of the authorization code 615B that is available to the portable computing device 100. The authorization code 615B may take a physical form such as in the form of the printed receipt and/or a visual form such as a field or character generated on a computer display that is readable by the portable computing device 100. Alternatively, the authorization code 615B may be transmitted wirelessly from the payment token entry point 630 to the portable computing device 100. Wireless forms include, but are not limited to, radiofrequency communications, acoustic type communications, NFC type communications, infrared type communications, and other similar wireless mediums.

The authorization code 615 verifies that the owner of the unloaded account 607A is the entity requesting loading of the account 607A into the client device management server 106 that manages the mobile wallet system/vault 134. The authorization code 615 may be keyed-in by the operator of the PCD 100 and/or it can be transferred into the PCD 100 in the form of a machine-readable code such as a 2-D barcode, and OCR scan, an exchange of data using near field communications (NFC), infrared, and or acoustical transmissions between the PCD 102 and the payment entry point 630.

The authorization code 615 may comprise a unique identifier that is created by the mobile wallet system/vault 134. However, the authorization code 615 may also comprise any data/information relevant to the transaction that has been completed with the unloaded account 607A. For example, the authorization code 615 may comprise a sequence identifier, the total amount for the transaction waiting for approval, the tax amount. The mobile wallet system/vault 134 may employ a randomization function that randomly selects any one of the aforementioned pieces of information (i.e.—the authorization code 615 for a first transaction may comprise the total amount of the authorization code 615 for a second transaction may comprise the tax incurred for the transaction, etc.).

The authorization code 615 may comprise any a numeric string of characters having any length. According to one exemplary embodiment, the authorization code 615 may comprise a four character alphanumeric code. If the mobile wallet system/vault 134 matches the authorization code 615A in the temporary storage area 610 with the authorization code 615C, 615D and user ID 606B transmitted from the PCD 100 as set forth in block 740 of Method 700 described below, then in block 745, the mobile wallet system/vault 134 may issue a challenge question to the PCD 100 in order to confirm the identity of the operator of the PCD 100. Each PCD 100 may be assigned a unique identifier 606A, which may include elements such as a mobile phone number. While the mobile wallet system/vault 134 and the PCD 100 have been illustrated as being coupled together via a dashed line, this coupling via the dashed line may be a virtual one in which the PCD 100 uses the communications network 620 in order to transmit and receive data from the mobile wallet system/vault 134.

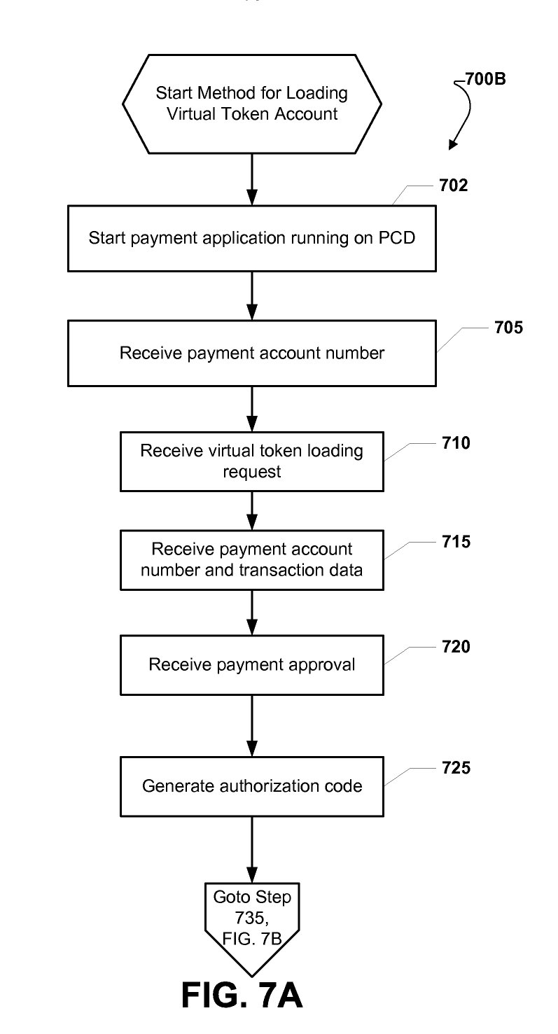

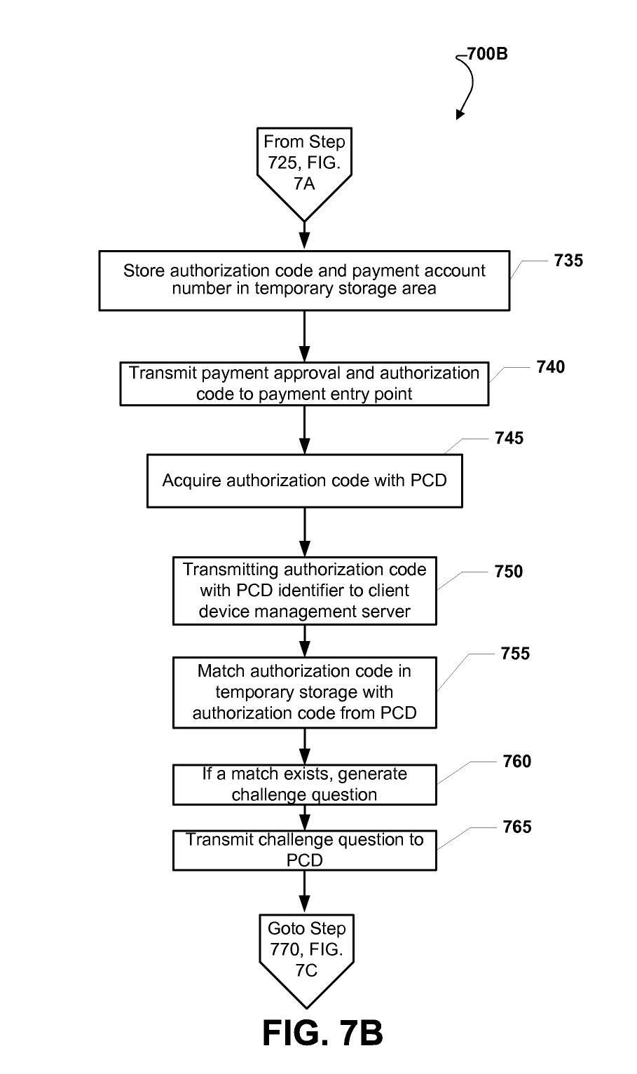

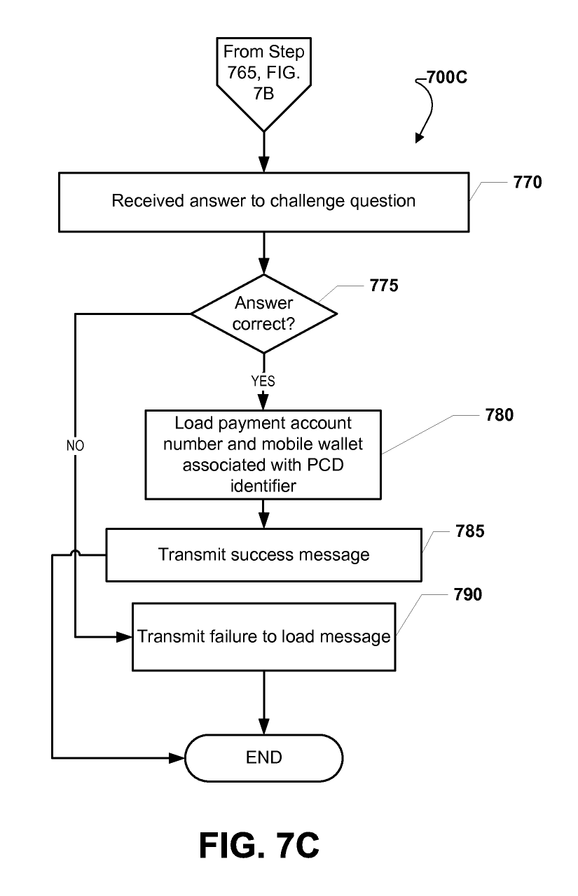

FIG. 7A is a flowchart illustrating a method 700 for loading a virtual token 533 of a mobile wallet system 101. Block 702 is the first block of method 700A. In block 702, a payment application running on the PCD 100, such as a mobile wallet 414 program, may be initialized by an operator.

Next, in block 705, the system 600 may receive a payment account number such as the unloaded account number 607A from a physical token 642 via the payment token entry point 630. As noted above, the payment token entry point 630 may comprise any type of point-of-sale (“POS”) device, such as, but not limited to, a terminal, a kiosk, and other similar devices which may also include a magnetic stripe reader, a barcode reader, a near field communications (“NFC”) reader, a reader that uses Bluetooth, a reader with Internet linking capability, and any combination thereof. Similarly, the traditional physical token 642 may include, but is not limited to, cards with magnetic stripes, cards with smart chips or integrated-circuit (“IC”) cards, NFC cards, cards with barcodes, etc.

Next, in block 710, the payment token entry point 630 may receive a virtual token loading request. In other words, the payment token entry point 630 may be programmed with a prompt in order to request the user of the physical token 642 if he or she wants the unloaded account number 607A to be loaded into the mobile wallet system/vault 134. For example, after reading the machine code from the physical token 642, the payment token entry point 630 may display a question, such as, “Do you want to load this card's account number into the mobile wallet system/vault 134 associated with your portable computing device 100?”

Subsequently, in block 715, the payment processing point 625 receives the payment account number or tokenized version of the account number 607B and transaction data, such as the purchase price and merchandise identifier. The payment processing point 625 transmits the account number 607B and merchandise identifier over the communications network 620 to appropriate payment processing systems such as the account processor/issuer server 108 as illustrated in FIG. 4. Parallel to this transmission to the account processor/issuer server 108, the payment processing point 625 also transmits the account number 607B and merchandise identifier to the mobile wallet system/vault 134.

Next, in block 720, the payment processing point 625 may receive payment approval from the account processor/issuer server 108. Subsequently, or in parallel to block 720, in block 725 the mobile wallet system/vault 134 may generate the authorization code 615A as illustrated above in FIG. 6 in response to receiving the unloaded account number or token 607C and merchandise identifier (if any). The mobile wallet system/vault 134 may transmit the authorization code 615B over the communications network 620 to the payment processing point 625. Block 725 may or may not be conditioned upon receiving the payment approval in block 720. In some scenarios, it is possible for a user of a physical token 642 to make a virtual token loading request with the payment token entry point 630 without completing a consumer transaction. In other words, the user of a physical token 642 may have the physical token 642 scan/read by the payment token entry point 630 without completing any transaction such as a purchase in order to just transmit the unloaded account number 607A to the mobile wallet system/vault 134. The method 700A than proceeds to block 735 method 700B in FIG. 7B.

FIG. 7B is a continuation flowchart of FIG. 7A illustrating the method 700 for loading a virtual token of the mobile wallet system 101. In block 735, the mobile wallet system/vault 134 may store the authorization code 615A and the payment account number 607C in a temporary storage area 610 as described above in connection with FIG. 6. In parallel to block 735 or a subsequent to block 735, the payment processing point 625 may transmit the payment approval and authorization code 615B to the payment token entry point 630 in block 740.

In block 745, the authorization code 615B may be acquired with the portable computing device 100. As described above, the authorization code 615B may take a physical form such as in the form of the printed receipt and/or a visual form such as a field or character generated on a computer display that is readable by the portable computing device 100, such as a 1-D or 2-D bar code. Alternatively, the authorization code 615B may be transmitted wirelessly from the payment token entry point 630 to the portable computing device 100. Wireless forms include, but are not limited to, radiofrequency communications, acoustic type communications, NFC type communications, infrared type communications, and other similar wireless mediums.

In block 750, the PCD 100 transmits the authorization code 615C that was acquired in block 745, and transmits this code 615C along with a user identifier 606A that is associated with the PCD 100 over the communications network 620 to the mobile wallet system/vault 134. As noted previously, this user identifier 606A may take on any number of forms. It may comprise an alphanumeric string of characters, such as a mobile telephone number or other similar types of identifiers.

In block 755, the mobile wallet system/vault 134 may match the authorization code 615C received from the PCD 100 with the authorization code 615A generated by the mobile wallet system/vault 134. Next, in block 760, if a match exists between the two codes 615A, 615C, then the mobile wallet system/vault 134 may generate a challenge question for security purposes. This challenge question may be selected by the operator of the PCD 100 and/or it may be randomly selected by the mobile wallet system/vault 134 based on the existing mobile wallet account established by the operator of the PCD 100. When a match exists between the authorization codes 615, the mobile wallet system/vault 134 may access the secured area 605 with the user identifier 606B in order to retrieve sensitive account information for the security question. For example, the mobile wallet system/vault 134 may generate a challenge question that request the operator of the PCD 100 to provide the mailing ZIP code associated with the unloaded account number 607A that was read from the token 642 by the payment token entry point 630.

This challenge question may be transmitted over the communications work 620 from the mobile wallet system/vault 134 to the PCD 100 in block 765. The method 700B then proceeds to FIG. 7C in block 770.

FIG. 7C is a continuation flowchart of FIG. 7B illustrating the method 700 for loading a virtual token of the mobile wallet system 101. In block 770, the mobile wallet system/vault 134 may receive the answer from the PCD 100 to the challenge question which was transmitted over the communications network 620.

Next, in decision block 775, the mobile wallet system/vault 134 determines if the answer received matches the answer on file for the unloaded account number 607A. If the inquiry to decision block 775 is negative, then the “NO” branch is followed to block 790 in which the mobile wallet system/vault 134 generates and transmits a failure to load message to the portable computing device 100.

If the inquiry to decision block 775 is positive, then the “YES” branch is followed to block 780 in which the mobile wallet system/vault 134 loads the payment account number into the mobile wallet system 101 based on the user identifier 606B. Next, in block 785, the mobile wallet system/vault 134, generates and transmits a successful virtual card loading message to the PCD 100 over the communications network 620. The process then ends.

At the end of method 700, the operator of a PCD 100 may now access the loaded account 142 as illustrated in FIG. 4 and as illustrated in FIG. 5. Particularly with respect to FIG. 5A, the operator of the PCD 100 may now display the virtual card 533 for completing a transaction instead of utilizing a physical token 642.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method for loading a virtual card of a mobile wallet system comprising:
receiving a payment account number from a token;
transmitting one of a payment account number and token over a communications network;
generating a first authorization code in response to receiving the payment account number or token;
transmitting the first authorization code over the communications network;
relaying the first authorization code to a portable computing device;
receiving a second authorization code from the communications network;
determining if the first and second authorization codes match; and
if the first and second authorization codes match, then loading the payment account number into the mobile wallet system.

2. The method of claim 1, wherein receiving a payment account number from a token comprises reading the payment account number with a machine.

3. The method of claim 2, wherein the machine comprises at least one of a magnetic stripe reader, a barcode reader, a near field communications (“NFC”) reader, a reader that uses radio-frequency communications, and a portable computing device coupled to the Internet.

4. The method of claim 1, wherein the token comprises at least one of a card with a magnetic stripe, a card with a smart chip or integrated-circuit (“IC”), a card that uses near-field-communications (“NFC”), a card with a barcode, a mobile device with a system that uses NFC, and a mobile device bearing a bar code.

5. The method of claim 1, wherein each authorization code comprises an alphanumeric text string.

6. The method of claim 1, further comprising randomly selecting an alphanumeric text string for the first authorization code.

7. The method of claim 1, further comprising generating a challenge question in response to determining a match between the first and second authorizations codes.

8. The method of claim 1, further comprising displaying a virtual token loading request on a payment token entry point.

9. The method of claim 8, wherein the payment token entry point comprises at least one of a point-of-sale (“POS”) device, a terminal, and a kiosk.

10. The method of claim 1, further comprising transmitting an identifier associated with the portable computing device in conjunction with the second authorization code over the communications network.

11. A computer system for loading a virtual card of a mobile wallet system, the computer system comprising:
a processor operable for:
receiving a payment account number from a token;
transmitting one of a payment account number and token over a communications network;
generating a first authorization code in response to receiving the payment account number or token;
transmitting the first authorization code over the communications network;
relaying the first authorization code to a portable computing device;
receiving a second authorization code from the communications network;
determining if the first and second authorization codes match; and
if the first and second authorization codes match, then loading the payment account number into the mobile wallet system.

12. The system of claim 11, wherein the processor being operable for receiving a payment account number from a token comprises the processor receiving a reading of the payment account number with a machine.

13. The system of claim 12, wherein the machine comprises at least one of a magnetic stripe reader, a barcode reader, a near field communications (“NFC”) reader, a reader that uses radio-frequency communications, and a portable computing device coupled to the Internet.

14. The system of claim 11, wherein the token comprises at least one of a card with a magnetic stripe, a card with a smart chip or integrated-circuit (“IC”), a card that uses near-field-communications (“NFC”), a card with a barcode, a mobile device with a system that uses NFC, and a mobile device bearing a bar code.

15. The system of claim 11, wherein the wherein each authorization code comprises an alphanumeric text string.

16. The system of claim 11, wherein the processor operable for randomly selecting an alphanumeric text string for the first authorization code.

17. The system of claim 11, wherein the processor is further operable for generating a challenge question in response to determining a match between the first and second authorizations codes

18. The system of claim 11, wherein the processor is further operable for generating a virtual token loading request for display on a payment token entry point.

19. The system of claim 18, wherein the payment token entry point comprises at least one of a point-of-sale (“POS”) device, a terminal, and a kiosk.

20. The system of claim 11, wherein the processor is operable for receiving an identifier associated with the portable computing device in conjunction with the second authorization code over the communications network.

21. A computer system for loading a virtual card of a mobile wallet system, the computer system comprising:
means for receiving a payment account number from a token;
means for transmitting one of a payment account number and token over a communications network;
means for generating a first authorization code in response to receiving the payment account number or token;
means for transmitting the first authorization code over the communications network;
means for relaying the first authorization code to a portable computing device;
means for receiving a second authorization code from the communications network;
means for determining if the first and second authorization codes match; and
means for loading the payment account number into the mobile wallet system if the first and second authorization codes match.

22. The system of claim 21, wherein the means for receiving a payment account number from a token further comprises means for reading the payment account number.

23. The system of claim 22, wherein the means for reading comprises at least one of a magnetic stripe reader, a barcode reader, a near field communications (“NFC”) reader, a reader that uses radio-frequency communications, and a portable computing device coupled to the Internet.

24. The system of claim 21, wherein the token comprises at least one of a card with a magnetic stripe, a card with a smart chip or integrated-circuit (“IC”), a card that uses near-field-communications (“NFC”), a card with a barcode, a mobile device with a system that uses NFC, and a mobile device bearing a bar code.

25. The system of claim 21, wherein each authorization code comprises an alphanumeric text string.

26. The method of claim 21, further comprising means for randomly selecting an alphanumeric text string for the first authorization code.

27. The system of claim 21, further comprising means for generating a challenge question in response to determining a match between the first and second authorizations codes.

28. The system of claim 21, further comprising means for displaying a virtual token loading request on a payment token entry point.

29. The system of claim 21, wherein the payment token entry point comprises at least one of a point-of-sale (“POS”) device, a terminal, and a kiosk.

30. The system of claim 21, further comprising means for transmitting an identifier associated with the portable computing device in conjunction with the second authorization code over the communications network.

31. A computer program product comprising a computer usable medium having a computer readable program code embodied therein, said computer readable program code adapted to be executed to implement a method for a virtual card of a mobile wallet system, said method comprising:
receiving a payment account number from a token;
transmitting one of a payment account number and token over a communications network;
generating a first authorization code in response to receiving the payment account number or token;
transmitting the first authorization code over the communications network;
relaying the first authorization code to a portable computing device;
receiving a second authorization code from the communications network;
determining if the first and second authorization codes match; and
if the first and second authorization codes match, then loading the payment account number into the mobile wallet system.

32. The computer program product of claim 31, wherein receiving a payment account number from a token comprises reading the payment account number with a machine.

33. The computer program product of claim 32, wherein the machine comprises at least one of a magnetic stripe reader, a barcode reader, a near field communications (“NFC”) reader, a reader that uses radio-frequency communications, and a portable computing device coupled to the Internet.

34. The computer program product of claim 31, wherein the token comprises at least one of a card with a magnetic stripe, a card with a smart chip or integrated-circuit (“IC”), a card that uses near-field-communications (“NFC”), a card with a barcode, a mobile device with a system that uses NFC, and a mobile device bearing a bar code.

35. The computer program product of claim 31, wherein each authorization code comprises an alphanumeric text string.

36. The computer program product of claim 31, wherein the program code implementing the method further comprises:
randomly selecting an alphanumeric text string for the first authorization code.

37. The computer program product of claim 31, wherein the program code implementing the method further comprises:
generating a challenge question in response to determining a match between the first and second authorizations codes.

38. The computer program product of claim 31, wherein the program code implementing the method further comprises:
displaying a virtual token loading request on a payment token entry point.

39. The computer program product of claim 38, wherein the payment token entry point comprises at least one of a point-of-sale (“POS”) device, a terminal, and a kiosk.

40. The computer program product of claim 31, wherein the program code implementing the method further comprises:
transmitting an identifier associated with the portable computing device in conjunction with the second authorization code over the communications network.
